(19) United States
(12) Patent Application Publication
(10) Pub. No.: US 2025/0138188 A1
(43) Pub. Date: May 1, 2025

(54) UNMANNED VEHICLE PROCESSING SYSTEM AND UNMANNED VEHICLE PROCESSING METHOD

(71) Applicant: Industrial Technology Research Institute, Hsinchu (TW)

(72) Inventors: CHIH-CHUN CHEN, Kaohsiung City (TW); CHIEN-HUNG LU, Tainan City (TW); CHIH-YU TSAI, Tainan City (TW); YU-CHENG SONG, Tainan City (TW)

(21) Appl. No.: 18/531,017

(22) Filed: Dec. 6, 2023

(30) Foreign Application Priority Data
Oct. 26, 2023 (TW) 112141094

(51) Int. Cl. G01S 17/08; G01S 7/48; G01S 7/4865; G01S 7/497

(52) U.S. Cl. CPC G01S 17/08; G01S 7/4808; G01S 7/4865; G01S 7/497

(57) ABSTRACT

An unmanned vehicle processing system includes a controller, a laser source, a galvanometer module and a receiving device. The controller provides a laser trigger signal. The laser source is connected electrically to the controller, receives the laser trigger signal and further emits accordingly a laser beam. The galvanometer module includes a scanning galvanometer for reflecting and converting the laser beam into a processing beam. The receiving device is connected electrically to the controller, receives a processing reflected beam reflected from the object and further emits correspondingly a reflected reception signal to the controller. The controller obtains a processing distance between the unmanned vehicle and the object according to the reflected reception signal and the laser trigger signal, the reflected reception signal has a reflected-signal intensity, and the controller detects a processed state of the object according to the reflected-signal intensity. In addition, an unmanned vehicle processing method is also provided.

### CROSS REFERENCE TO RELATED APPLICATION

This application claims the benefits of Taiwan application Serial No. 112141094, filed on Oct. 26, 2023, the disclosures of which are incorporated by references herein in its entirety.

### TECHNICAL FIELD

The present disclosure relates in general to an unmanned vehicle processing system and an unmanned vehicle processing method.

### BACKGROUND

In engineering, when an equipment structure is used for a period of time, deterioration to some degree that requires further processing would be inevitable. For example, if a steel plate breaks or a steel product is corroded, welding or rust removal will be required. Or, if a steel product is deformed, then relevant cutting might be necessary.

Common processing methods in industry include mechanical processing, manual processing, drone processing and other operations. Among them, the manual processing is the most meticulous, but requires long working hours, low efficiency, high labor intensity, and is limited by the on-site environment.

Take rust removal as an example. Currently, petrochemical and steel companies usually prepare high annual maintenance budgets for rust removal or repainting facilities. Generally, high rise constructions such as barrel troughs require scaffolding operations, and a large amount of manpower would be required for such maintenance. Although climbing robots may be able to meet most of usage scenarios, yet the drone provides a flexible hovering operation mode to reduce manpower and/or material loss. Definitely, the drone has a potential to provide more operation modes (such as normal mode or tethered mode) to satisfy all possible needs in the rust removal and painting operations on tall 3D structures. However, the rust removal operations by the drone require maintaining stable and continuous processing within a quite limited range. In other words, if the drone is operated in the open atmosphere or in a space without stable flow, then the operation instability caused by unexpected rotations or deviations in the processing path may lead to a much poorer result in the rust removal.

### SUMMARY

An object of the present disclosure is to provide an unmanned vehicle processing system and an unmanned vehicle processing method to enhance the processing stability of the unmanned vehicle, to detect a processed state of an object, and to increase the processing efficiency.

In one embodiment of this disclosure, an unmanned vehicle processing system, suitable for an unmanned vehicle for processing an object, includes a controller, a laser source, a galvanometer module and a receiving device. The controller is configured for providing a laser trigger signal. The laser source is connected electrically to the controller, and is configured for receiving the laser trigger signal and further emitting a laser beam according to the laser trigger signal. The galvanometer module includes a scanning galvanometer configured for reflecting and converting the laser beam into a processing beam to process the object. The receiving device is connected electrically to the controller, and is configured for receiving a processing reflected beam reflected from the object and further emitting correspondingly a reflected reception signal to the controller. The controller obtains a processing distance between the unmanned vehicle and the object according to the reflected reception signal and the laser trigger signal, the reflected reception signal has a reflected-signal intensity, and the controller detects a processed state of the object according to the reflected-signal intensity.

In another embodiment of this disclosure, an unmanned vehicle processing method, suitable for an unmanned vehicle for processing an object, comprises the steps of: providing a laser trigger signal according to a processing position of the unmanned vehicle with respect to the object, and emitting a laser beam to process the object according to the laser trigger signal; receiving a processing reflected beam reflected from the object processed by the laser beam, and generating correspondingly a reflected reception signal; according to the laser trigger signal and the reflected reception signal, calculating a time of flight so as to obtain a processing distance between the unmanned vehicle and the object; and, according to a reflected-signal intensity of the reflected reception signal, detecting a processed state of the object.

As stated, in the unmanned vehicle processing system and the unmanned vehicle processing method of this disclosure, reflection of laser beams is utilized to calculate the processing distance between the unmanned vehicle and the object, such that the processing position of the unmanned vehicle with respect to the object can be kept within the most effective area. Thereupon, the processing stability of the unmanned vehicle can be ensured, the finish of the processing can be immediately detected through verifying the reflection intensity in the processed area, and further the laser source and the scanning galvanometer can be adjusted to promote the processing efficiency.

Further, according to this disclosure, the reflected laser beams of the laser processing are utilized to detect the processing distance and the processed state of the object, no more additional equipment such as the ultrasonic ranging device is required, no more expensive LiDAR equipment is needed, and no more additional facilities or visual equipment for detecting the processed state of the object is necessary, such that the price and the cost can be much preferable.

Further scope of applicability of the present application will become more apparent from the detailed description given hereinafter. However, it should be understood that the detailed description and specific examples, while indicating exemplary embodiments of the disclosure, are given by way of illustration only, since various changes and modifications within the spirit and scope of the disclosure will become apparent to those skilled in the art from this detailed description.

### BRIEF DESCRIPTION OF THE DRAWINGS

The present disclosure will become more fully understood from the detailed description given herein below and the accompanying drawings which are given by way of illustration only, and thus are not limitative of the present disclosure and wherein:

FIG. 1 is a schematic view of an exemplary example of processing of the unmanned vehicle processing system in accordance with this disclosure;

FIG. 2 is a schematic view of an embodiment of the unmanned vehicle processing system in accordance with this disclosure;

FIG. 3 is a schematic view of an embodiment of the unmanned vehicle processing system in accordance with this disclosure;

FIG. 4 is a schematic flowchart of an embodiment of the unmanned vehicle processing method in accordance with this disclosure;

FIG. 5 is a schematic view of an embodiment of the unmanned vehicle processing method in accordance with this disclosure;

FIG. 6 is a schematic view of another embodiment of the unmanned vehicle processing method in accordance with this disclosure; and

FIG. 7 is a schematic view of a further embodiment of the unmanned vehicle processing method in accordance with this disclosure.

### DETAILED DESCRIPTION

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

Embodiments listed below are described in detail with accompanying drawings, but these embodiments are not intended to limit the scope of the present disclosure. In addition, the accompanying drawings are for illustration purposes only and are not drawn according to the original dimensions. In order to facilitate understanding, the same components will be labeled with the same symbols in the following description.

Terms “include”, “have”, etc. mentioned in this disclosure are all open terms, which means simply “include but not limited to”.

In the description of different embodiments, when terms such as “first”, “second”, “third”, “fourth”, etc. are used to describe elements, they are only used to distinguish a plurality of elements from each other, and do not limit order or importance of these elements.

In the description of different embodiments, the so-called “couple” or “connect” may refer to two or more elements that are in direct physical or electrical contact with each other, or that are in indirect physical or electrical contact with each other, and may also refer to the mutual operation or action of two or more elements.

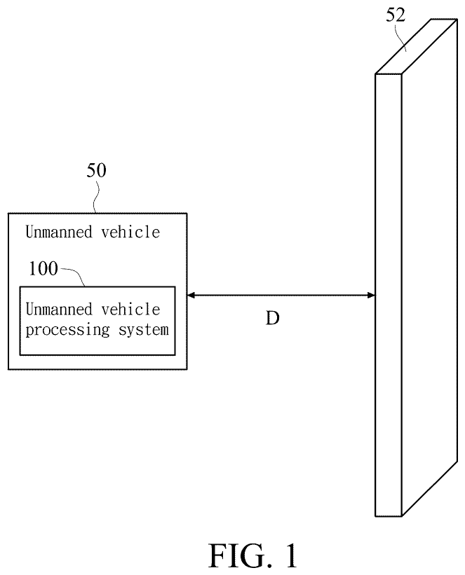

FIG. 1 is a schematic view of an exemplary example of processing of the unmanned vehicle processing system in accordance with this disclosure. Referring to FIG. 1, the unmanned vehicle processing system 100 disposed at an unmanned vehicle 50 is used for processing an object 52. The unmanned vehicle processing system 100 can be a system embedded inside the unmanned vehicle 50, or a system disposed on the unmanned vehicle 50 in a signally and electrically connected manner; but not limited thereto. In one embodiment, the unmanned vehicle 50 can be a drone or an unmanned aerial vehicle (UAV). When the unmanned vehicle 50 is moved to a processing position, the unmanned vehicle 50 spaced from the object 52 by a processing distance D is to perform processing (such as rust removal) upon the object 52. In some other embodiments, the unmanned vehicle 50 and the processing method can be adjusted according to practical situations. It shall be explained that the shape of the object 52 in the drawing (such as a rectangle) is only adopted for a description purpose, not for a limitation thereto. Practically, the object 52 to be processed can be an arbitrary form or size.

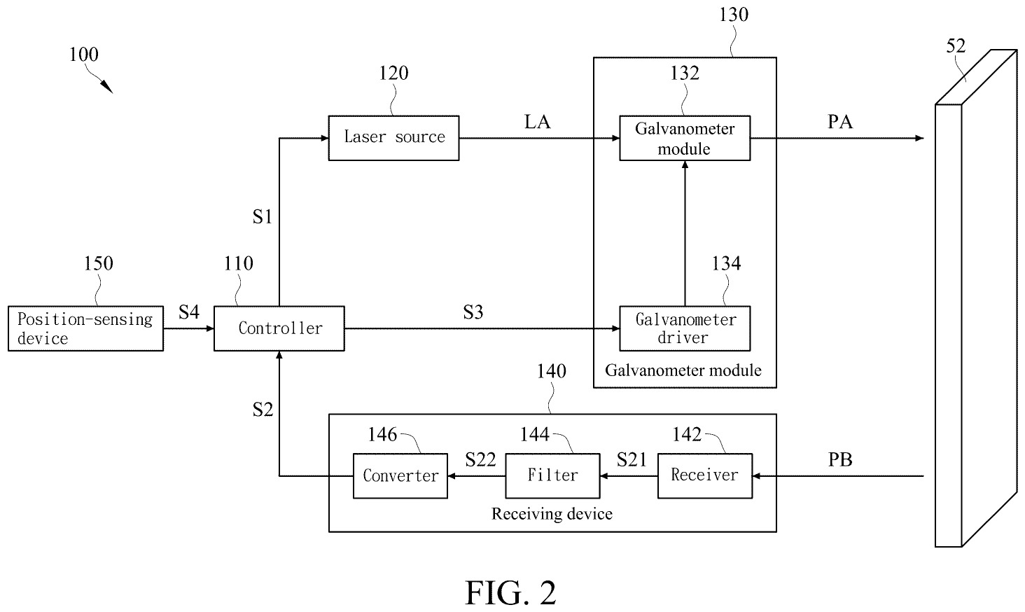

FIG. 2 is a schematic view of an embodiment of the unmanned vehicle processing system in accordance with this disclosure. Referring to FIG. 1 and FIG. 2, the unmanned vehicle processing system 100 of this disclosure, suitable for the unmanned vehicle 50, is to process the object 52. The unmanned vehicle processing system 100 includes a controller 110, a laser source 120, a galvanometer module 130, a receiving device 140 and a position-sensing device 150. The controller 110 is connected electrically to the laser source 120, the receiving device 140 and the position-sensing device 150.

According to the processing distance D between the unmanned vehicle 50 and the object 52 and laser control parameters such as a processed state of the object 52, the controller 110 would set a laser power for the laser source 120 and further provide a laser trigger signal S1. The laser source 120 would receive the laser trigger signal S1, and emit accordingly a laser beam LA.

The galvanometer module 130 includes a scanning galvanometer 132 and a galvanometer driver 134. The scanning galvanometer 132, is disposed between the laser source 120 and the object 52 (for example, at a position passed by the laser beam LA emitted by the laser source 120), and is provided for the laser beam LA to pass and be reflected to the object 52 for processing. The galvanometer driver 134, is connected electrically to the scanning galvanometer 132, and is used for driving and calibrating the scanning galvanometer 132. According to the processing distance D between the unmanned vehicle 50 and the object 52 and galvanometer control parameters such as the processed state of the object 52, the controller 110 is set to provide a galvanometer control signal S3. According to the galvanometer control signal S3, the galvanometer driver 134 drives the scanning galvanometer 132 to reflect the passing laser beam LA to form correspondingly a processing beam PA toward the object 52 so as to establish a scan-processing path. The scan-processing path can direct the processing beams PA to move laterally along the same direction, such that the processing beams PA can be used to process the object 52, such as rust removal, welding, cutting, carving, etc.

In one embodiment, the scanning galvanometer 132 can rotate. With the galvanometer driver 134 to drive the scanning galvanometer 132 to rotate by different angling, the laser beam LA incident to the scanning galvanometer 132 can be reflected out at a desired angle, such that the processing beam PA at a specific angle can be formed.

The processing beam PA would hit the object 52 to reflect a processing reflected beam PB. The receiving device 140 receives the processing reflected beam PB from the object 52, and then emits correspondingly a reflected reception signal S2 to the controller 110. According to the reflected reception signal S2 and the laser trigger signal S1, the controller 110 would obtain a time of flight (TOF) by calculating a feed-back time difference between the laser trigger signal S1 before the processing and the reflected reception signal S2 after the processing, and further derive the processing distance D between the unmanned vehicle 50 and the object 52. By maintaining the processing distance D between the unmanned vehicle 50 and the object 52, a processing position within an effective area for the unmanned vehicle 50 with respect to the object 52 can be ensured to raise the processing performance. In addition, according to the feed-back processing distance D between the unmanned vehicle 50 and the object 52, the controller 110 would adjust the required laser power for the laser source 120, and further update laser control parameters in the laser trigger signal S1, such that the processing efficiency can be promoted. For example, if the processing distance D is faraway, the laser power of the laser source 120 shall be upward adjusted so as to promote the processing efficiency. At the same time, the aforesaid reflected reception signal S2 has a reflected-signal intensity. The controller 110 can evaluate the reflected-signal intensity to detect the processed state of the object 52, by utilizing the ratio of light intensity before to after the processing to examine the processed state of the object 52. For example, regarding the processed state of the rust removal, it is easy to understand that, more complete the rust removal is, the reflected-signal intensity would be stronger. Thus, the aforesaid processed state of the object 52 is proportional to the reflected-signal intensity. In addition, regarding the processed state of the cutting, a successful cutting is usually implied that the corresponding reflected-signal intensity is weaker. Thus, the aforesaid processed state of the object 52 is inversely proportional to the reflected-signal intensity. As such, the concerned processing can be confirmed to meet an end smoothly or not. Further, according to an intensity of the feed-back reflected-signal intensity, the controller 110 would adjust the required laser power of the laser source 120. For example, if the reflected-signal intensity is weaker, the laser power of the laser source 120 would be raised to promote the processing efficiency.

In one embodiment, the receiving device 140 includes a receiver 142, a filter 144 and a converter 146. The receiver 142 can be a photodetection diode (PD) or an avalanche photodetection diode (APD) for receiving the processing reflected beam PB, and is configured for emitting a received signal S21 to the filter 144 according to the processing reflected beam PB. The filter 144 is configured for filtering out noises off the received signal S21, and for filtering out a useful laser pulse signal S22 to the converter 146. The converter 146 can be an analog-to-digital converter (ADC) for converting the laser pulse signal S22 into the reflected reception signal S2 that the controller 110 can read, and the converter 146 can also judge and calculate a reflected-signal intensity of the reflected reception signal S2. In some other embodiments, the receiving device 140 can include arbitrary component to meet practical needs.

The position-sensing device 150 is configured for sensing if the position of the unmanned vehicle 50 is deviated or not. The position-sensing device 150 can calculate the position deviation of the unmanned vehicle 50 caused by foreign forcing, and thereby emit a position-calibrating signal S4 to the controller 110 for compensating the position of the unmanned vehicle 50. According to the position-calibrating signal S4, the controller 110 would provide the galvanometer control signal S3 being updated to the galvanometer driver 134. In other words, the galvanometer control signal S3 including the aforesaid galvanometer control parameters includes also calibration-adjustment parameters in response to the position-calibrating signal S4. According to the updated galvanometer control signal S3, the galvanometer driver 134 would adjust the position of the scanning galvanometer 132 to ensure that no deviation with respect to the scan-processing path would occur. In addition, the position-sensing device 150 can be an inertial sensor (such as a gyroscope) or any other appropriate position-sensing device; but not limited thereto.

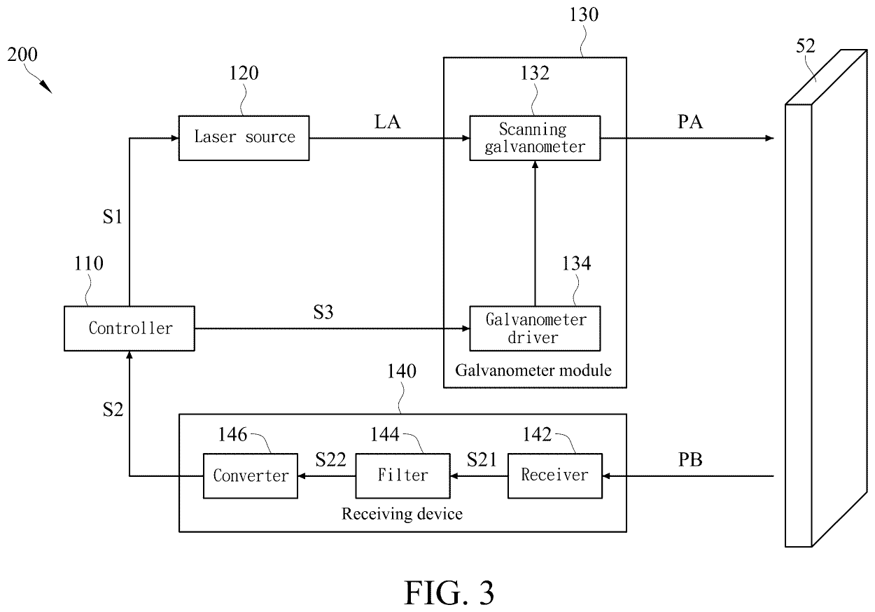

FIG. 3 is a schematic view of an embodiment of the unmanned vehicle processing system in accordance with this disclosure. Referring to FIG. 3, a difference between the unmanned vehicle processing system 200 of this embodiment and the unmanned vehicle processing system 100 of FIG. 2 is that, in this embodiment, the unmanned vehicle processing system 200 is not equipped with the position-sensing device 150. Thus, in this embodiment, the galvanometer control signal S3 is set only according to the galvanometer control parameters.

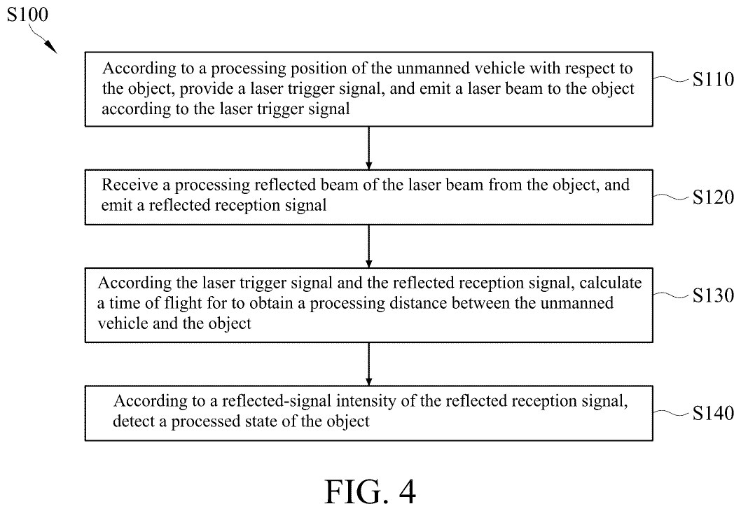

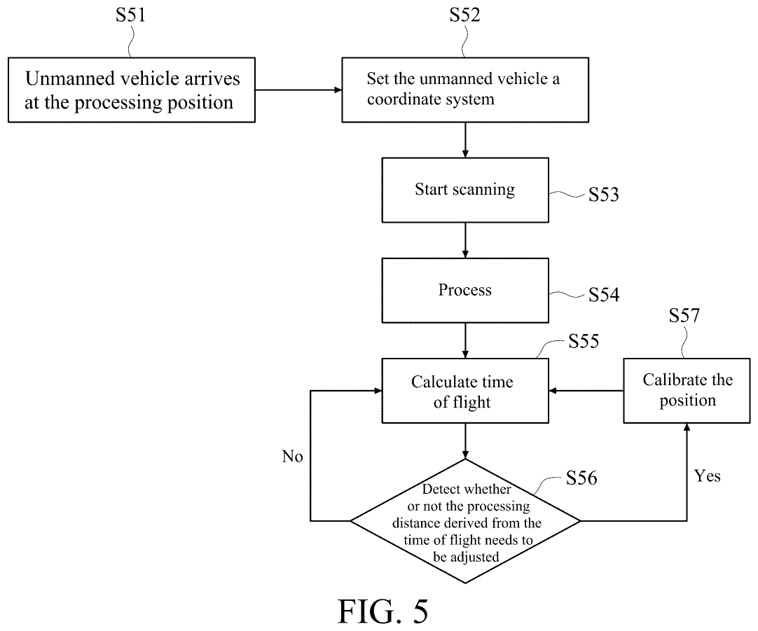

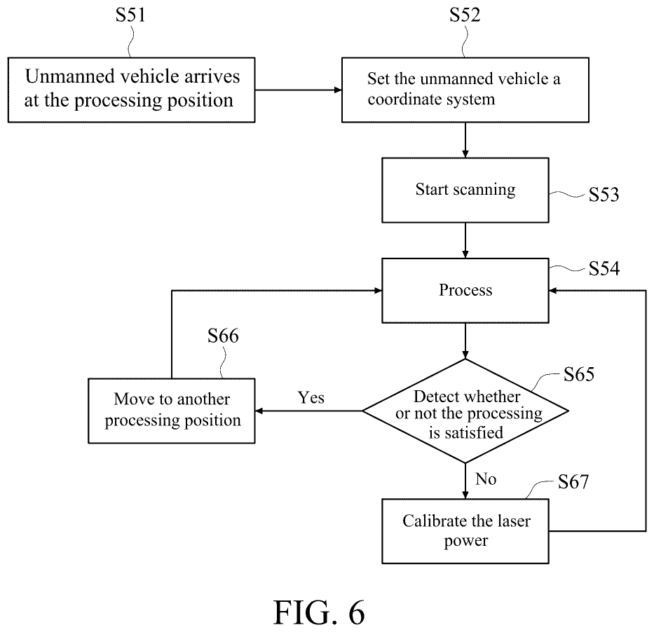

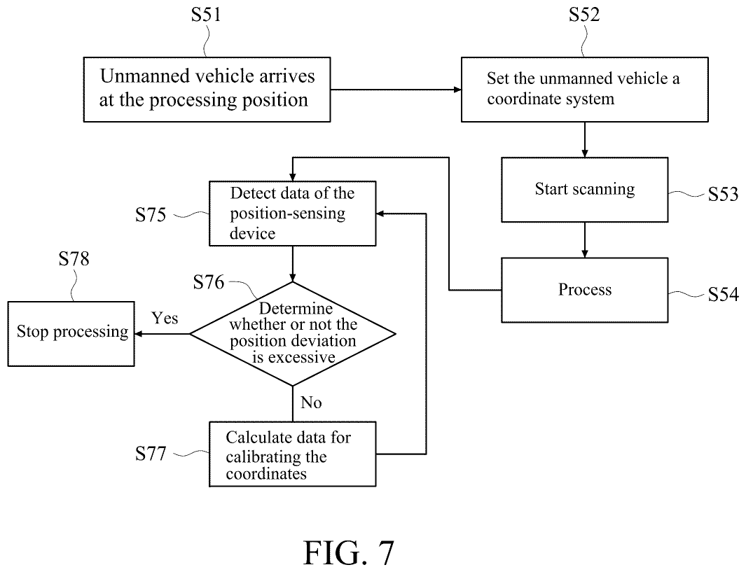

FIG. 4 is a schematic flowchart of an embodiment of the unmanned vehicle processing method in accordance with this disclosure. FIG. 5 is a schematic view of an embodiment of the unmanned vehicle processing method in accordance with this disclosure. FIG. 6 is a schematic view of another embodiment of the unmanned vehicle processing method in accordance with this disclosure. FIG. 7 is a schematic view of a further embodiment of the unmanned vehicle processing method in accordance with this disclosure. Firstly, referring to FIG. 1 to FIG. 5, the unmanned vehicle processing method S100 of this embodiment includes steps S110-S140. In performing Step S110, according to a processing position of the unmanned vehicle 50 with respect to the object 52, a laser trigger signal S1 is provided, and a laser beam LA for processing the object 52 is emitted to the object 52 according to the laser trigger signal S1. In detail, after the unmanned vehicle 50 arrives at the processing position, as shown in FIG. 5 and FIG. 1 in Step S51, and then, in Step S52, a coordinate system for the unmanned vehicle 50 is set, such that a processing distance D between the unmanned vehicle 50 and the object 52 can be clearly specified.

Then, in Step S53, the scanning is started. As shown in FIG. 2, the scanning galvanometer 132 would follow the galvanometer control signal S3 to have the laser beam LA be reflected by the scanning galvanometer 132 to form a processing beam PA to the object 52; i.e., establishing a scan-processing path. Then, in Step S54, processing is executed to have the processing beam PA process the object 52.

In the aforesaid processing, in Step S120 of FIG. 4, receive a reflected beam PB reflected by the object 52 from the laser beam LA for processing the object 52, and emit a reflected reception signal S2. As shown in FIG. 2, the processing beam PA hits the object 52 and reflects thereby a processing reflected beam PB, and the receiving device 140 receives the processing reflected beam PB from the object 52 and emits the reflected reception signal S2 to the controller 110.

Then, in performing Step S130, according to the reflected reception signal S2 and the laser trigger signal S1, calculating a time of flight (TOF) to obtain the processing distance D between the unmanned vehicle 50 and the object 52. As shown in FIG. 2, the controller 110 would evaluate and compute the feed-back time difference between the reflected reception signal S2 after the processing and the laser trigger signal S1 before the processing so as to further calculate the processing distance D between the unmanned vehicle 50 and the object 52.

In one embodiment, as shown in FIG. 5, in Step S55, the time of flight is calculated to obtain the processing distance D between the unmanned vehicle 50 and the object 52. Then, in Step S56, it is determined whether or not the processing distance D derived from the time of flight needs to be adjusted. If negative, it is ensured that the unmanned vehicle 50 is at the processing position within an effective area with respect to the object 52, and then go back to Step S55 to continuously calculate the processing distance D derived from the time of flight. On the other hand, if the determination of S56 is positive, then go to Step S57 for calibrating the position. At this time, the processing position of the unmanned vehicle 50 is adjusted to maintain the processing distance D between the unmanned vehicle 50 and the object 52 in order to ensure the processing position is within the effective area.

Referring back to FIG. 4 and FIG. 2, in performing Step S140, according to a reflected-signal intensity of the reflected reception signal S2, detecting a processed state of the object 52. The controller 110 can evaluate the reflected-signal intensity to realize the processed state of the object 52. That is, a ratio or percentage of the light intensities before and after the processing is used to examine the instant processed state of the object 52. Then, according to the processed state of the object 52, the processing position of the unmanned vehicle 50 would be adjusted, or the laser beam LA would be adjusted by calibrating the laser power of the laser source 120. For example, as shown in FIG. 6, explanations for Step S51 to Step S54 would follow those in FIG. 5. Then, in performing Step S65, it is detected whether or not the processing is satisfied. Namely, the aforesaid reflected-signal intensities are used to determine the processed state of the object 52. For example, in a rust removal, a determination whether or not the reflected-signal intensity is higher than a threshold value can be used to judge that the rust on the object 52 is removed or not. If positive, then go to Step S66 for moving to another processing position. That is, the unmanned vehicle 50 is moved to another processing position, and then go back to Step S54 for further processing. On the other hand, if the determination of S65 is negative, then go to Step S67 for calibrating the laser power. As shown in FIG. 2, the controller 110 can follow the feed-back reflected-signal intensity (i.e., the processed state of the object 52) to adjust the laser power required by the laser source 120, and then go back to Step S54 for further processing to promote the processing efficiency.

As shown in FIG. 7, also referring to FIG. 2, in the aforesaid processing, a position-sensing device 150 is provided to sense whether or not the unmanned vehicle 50 is deviated from the processing position, and further to calculate data for calibrating the relative coordinates for compensating the processing position of the unmanned vehicle 50. In performing Step S75, data of the position-sensing device 150 is detected. The position-sensing device 150 is configured for sensing whether or not the processing position of the unmanned vehicle 50 is deviated. The position-sensing device 150 can calculate the position deviation of the unmanned vehicle 50 caused by external force. In Step S76, it is determined whether or not the position deviation is excessive. If negative, it is determined that the processing position of the unmanned vehicle 50 is deviated, but the position deviation is not excessive. In Step S77, data for calibrating the coordinates is calculated. The position-sensing device 150 evaluates the position deviation of the unmanned vehicle 50 to derive data for calibrating the coordinates, and thereby a position-calibrating signal S4 is emitted to the controller 110 for compensating the processing position of the unmanned vehicle 50. Further, the unmanned vehicle 50 is kept processing and the data of the position-sensing device 150 is continuously detected in Step S75. On the other hand, if the decision is positive, then the processing position of the unmanned vehicle 50 is deviated, and particularly by an excessive position deviation. In this situation, since the processing position of the unmanned vehicle 50 is excessively deviated, and it is believed that any sufficient compensation thereto would exceed a reachable physical measurement the scanning galvanometer 132 can provide itself, thus the processing would be stopped to prevent the laser from touching an area other than the predetermined processing area, and thereby any accident from a deviated laser beam can be avoided.

In summary, in the unmanned vehicle processing system and the unmanned vehicle processing method of this disclosure, reflection of laser beams is utilized to calculate the processing distance between the unmanned vehicle and the object, such that the processing position of the unmanned vehicle with respect to the object can be kept within the most effective area. Thereupon, the processing stability of the unmanned vehicle can be ensured, the finish of the processing can be immediately detected through verifying the reflection intensity in the processed area, and further the laser source and the scanning galvanometer can be adjusted to promote the processing efficiency.

Further, according to this disclosure, the reflected laser beams of the laser processing are utilized to detect the processing distance and the processed state of the object, no more additional equipment such as the ultrasonic ranging device is required, and no more expensive LiDAR equipment is needed, and no more additional facilities for detecting the processed state of the object is necessary, such that the price and the cost can be much preferable.

In addition, this disclosure can control the scan positions, and can utilize the position-sensing device to calculate and further compensate the position deviation of the unmanned vehicle caused by external force, so that the scan stability can be enhanced.

With respect to the above description then, it is to be realized that the optimum dimensional relationships for the parts of the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present disclosure.

What is claimed is:

1. An unmanned vehicle processing system, applied to an unmanned vehicle for processing an object, comprising:
a controller, configured for providing a laser trigger signal;
a laser source, connected electrically to the controller, configured for receiving the laser trigger signal and further emitting a laser beam according to the laser trigger signal;
a galvanometer module, including a scanning galvanometer configured for reflecting and converting the laser beam into a processing beam to process the object; and
a receiving device, connected electrically to the controller, configured for receiving a processing reflected beam reflected from the object and further emitting correspondingly a reflected reception signal to the controller;
wherein the controller obtains a processing distance between the unmanned vehicle and the object according to the reflected reception signal and the laser trigger signal, the reflected reception signal has a reflected-signal intensity, and the controller detects a processed state of the object according to the reflected-signal intensity.

2. The unmanned vehicle processing system of claim 1, further including a position-sensing device connected electrically to the controller and configured for sensing a position of the unmanned vehicle.

3. The unmanned vehicle processing system of claim 2, wherein the position-sensing device is a gyroscope.

4. The unmanned vehicle processing system of claim 1, wherein the galvanometer module includes a galvanometer driver connected electrically to the scanning galvanometer and the controller, and the galvanometer driver is configured for driving the scanning galvanometer.

5. The unmanned vehicle processing system of claim 1, wherein the receiving device includes a receiver, a filter and a converter, the receiver receives the processing reflected beam and emits a received signal to the filter according to the processing reflected beam, the filter filters the received signal to obtain a laser pulse signal, and the converter converts the laser pulse signal into the reflected reception signal.

6. An unmanned vehicle processing method, applied to an unmanned vehicle for processing an object, comprising the steps of:
providing a laser trigger signal according to a processing position of the unmanned vehicle with respect to the object, and emitting a laser beam to process the object according to the laser trigger signal;
receiving a processing reflected beam reflected from the object processed by the laser beam, and generating correspondingly a reflected reception signal;
according to the laser trigger signal and the reflected reception signal, calculating a time of flight so as to obtain a processing distance between the unmanned vehicle and the object; and
according to a reflected-signal intensity of the reflected reception signal, detecting a processed state of the object.

7. The unmanned vehicle processing method of claim 6, after the step of calculating the time of flight, further including the steps of:
examining the time of flight to determine whether or not the processing distance needs to be adjusted;
if the examining is negative, then keeping examining the time of flight to determine whether or not the processing distance needs to be adjusted; and
if the examining is positive, then calibrating the processing position of the unmanned vehicle.

8. The unmanned vehicle processing method of claim 6, after the step of according to the reflected-signal intensity of the reception signal to detecting the processed state of the object, further including a step of: according to the processed state of the object, adjusting the processing position of the unmanned vehicle or calibrating a laser power of a laser source.

9. The unmanned vehicle processing method of claim 6, further including the steps of:
utilizing a position-sensing device to detect whether or not the unmanned vehicle has deviated the processing position; and
compensating the processing position of the unmanned vehicle.
